(19) United States
(12) Patent Application Publication
(10) Pub. No.: US 2011/0216408 A1
(43) Pub. Date: Sep. 8, 2011

(54) LINEARLY POLARIZED LIGHT CONVERTER

(75) Inventor: CHANG-CHING TSAI, TAIPEI CITY (TW)

(73) Assignees: CHANG-CHING TSAI, TAIPEI CITY (TW); LITE-ON TECHNOLOGY CORP., TAIPEI (TW)

(21) Appl. No.: 12/718,265

(22) Filed: Mar. 5, 2010

(51) Int. Cl. G02B 27/28; G02B 5/30

(52) U.S. Cl. 359/489.08

(57) ABSTRACT

A linearly polarized light converter uses a polarization recycling mechanism for separating a first linearly polarized wave of an unpolarized wave that includes orthogonal first and second linearly polarized waves and that is produced by a light source. The linearly polarized light converter includes a polarized beam splitter adapted to be disposed on a first side of the light source for receiving the unpolarized wave, transmitting the first linearly polarized wave therethrough, and reflecting the second linearly polarized wave. A metallic reflector is adapted to be disposed on a second side of the light source that is opposite to the first side, and includes a metal layer and a plurality of metal particles distributed over the metal layer to cooperatively define a rough surface which converts the reflected second linearly polarized wave into an elliptical polarized wave and which reflects the elliptical polarized wave therefrom.

### BACKGROUND OF THE INVENTION

1. Field of the Invention

This invention relates to a linearly polarized light converter, more particularly to a linearly polarized light converter for a micro-liquid-crystal projector.

2. Description of the Related Art

To accommodate the progress and development of science and technology, industries relating to the field of optoelectronics technology need to promote the polarization efficiency of a backlight module to satisfy the demand of high contrast ratio of the micro-liquid-crystal projection technology [that is, liquid crystal on silicon (LCOS)].

Referring to FIG. 1, a polarization converter 1, as disclosed in U.S. Publication No. 2009/0040608A1, includes a metallic diffraction grating 11 having protrusions and recesses arranged alternatingly, and a polarization beam splitter (PBS) 12 spaced apart from the metallic diffraction grating 11.

In the field of micro-liquid-crystal projection technology, the polarization converter 1 can be used to increase the output of linearly polarized light, which in turn can be used to promote the energy efficiency of the micro-liquid-crystal projector. Generally, unpolarized waves generated by a backlight module of a micro-liquid-crystal projector are mainly made up of random polarized light waves. The aforesaid linearly polarized light refers to light waves having a polarization direction that is fixed along a line, such as transverse magnetic waves (TM) or transverse electric waves (TE).

With reference to FIG. 1, it is worth mentioning that when an unpolarized light wave 10 contacts the polarization beam splitter 12, one of the TM and TE waves is permitted to pass through the polarization beam splitter 12, while the other one of the TM and TE waves is reflected. From the aforesaid description, it is apparent that if the total light energy produced by the backlight module is 100%, 50% of the energy is lost during the polarization conversion. Thus, the function of the metallic diffraction grating 11 on the polarization converter 1 is to convert the reflected linearly polarized light (for example, the TE wave) into an elliptically polarized light wave 10′ [which includes a combination of a linearly polarized light (TE wave) 101 and a linearly polarized light (TM wave) 102]. The metallic diffraction grating 11 reflects the elliptically polarized light wave 10′ back onto the polarized beam splitter 12. The linearly polarized light (TM wave) 102 is transmitted through the polarization beam splitter 12. Through such polarization recycling, the polarization conversion efficiency of the polarization converter 1 is promoted, and the energy conservation requirements of the micro-liquid-crystal projection technology are satisfied.

Since the metallic diffraction grating 11 has the protrusions and the recesses arranged in an alternating manner, for a cylindrical magnetic wave produced by a cold-cathode fluorescent lamp (CCFL), the polarization conversion efficiency of linearly polarized light is affected by the azimuth arrangement of the metallic diffraction grating 11. In other words, the grating vector of the metallic diffraction grating 11 and the incident plane of the cylindrical magnetic wave must have an included angle of about 45° so as to ensure high polarization conversion efficiency. In this regard, the cylindrical magnetic wave has only one incident plane. However, with regards to magnetic waves produced by other non-cylindrical light sources, there is not only one incident plane, so that it is not possible to adjust the azimuth of the grating vector so as to obtain good polarization conversion efficiency. Hence, with regards to the polarization converter 1 disclosed in U.S. Publication No. 2009/0040608A1, because the polarization converter 1 uses the metallic diffraction grating 11, it is suitable for use with a CCFL as the backlight source.

From the aforesaid description, it is apparent that in order to promote polarization efficiency, such a technical field involves many accurate and alternating photolithographic and etching steps to make the metallic diffraction grating 11. Not only is the consumption of time and equipment costs large, but due to the outer appearance and structure of the metallic diffraction grating 11, the metallic diffraction grating 11 is limited to cooperating with a CCFL as the light source of a backlight module. Hence, there is need in this field to reduce the production costs of the polarized converter and to allow for different types of non-cylindrical light sources to be used therewith.

### SUMMARY OF THE INVENTION

Therefore, the object of the present invention is to provide a linearly polarized light converter that is capable of overcoming the aforementioned drawbacks of the prior art.

According to this invention, a linearly polarized light converter uses a polarization recycling mechanism for separating a first linearly polarized wave of an unpolarized wave that includes the first linearly polarized wave and a second linearly polarized wave orthogonal with the first linearly polarized wave, and that is produced by a light source. The linearly polarized light converter comprises a polarized beam splitter and a metallic reflector. The polarized beam splitter is disposed on a first side of the light source for receiving the unpolarized wave, transmitting the first linearly polarized wave therethrough, and reflecting the second linearly polarized wave. The metallic reflector is disposed on a second side of the light source that is opposite to the first side, and includes a metal layer and a plurality of metal particles distributed over the metal layer to cooperatively define a rough surface. The rough surface converts the reflected second linearly polarized wave into an elliptical polarized wave, and reflects the elliptical polarized wave therefrom.

The efficacy of the present invention resides in providing a linearly polarized converter that has low production costs and that is suitable for use with non-cylindrical light sources, for example, a light emitting diode (LED) backlight light source that produces a spherical electromagnetic wave.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic view of a polarization converter disclosed in U.S. Publication No. 2009/0040608A1;

FIG. 2 is a schematic view of a polarization converter according to the preferred embodiment of this invention;

FIG. 3 is a fragmentary enlarged schematic view of the preferred embodiment; and

FIG. 4 is a 3D chart of power efficiencies of the polarization converter of the present invention at different wavelengths and incident angles.

### DETAILED DESCRIPTION OF THE PREFERRED EMBODIMENT

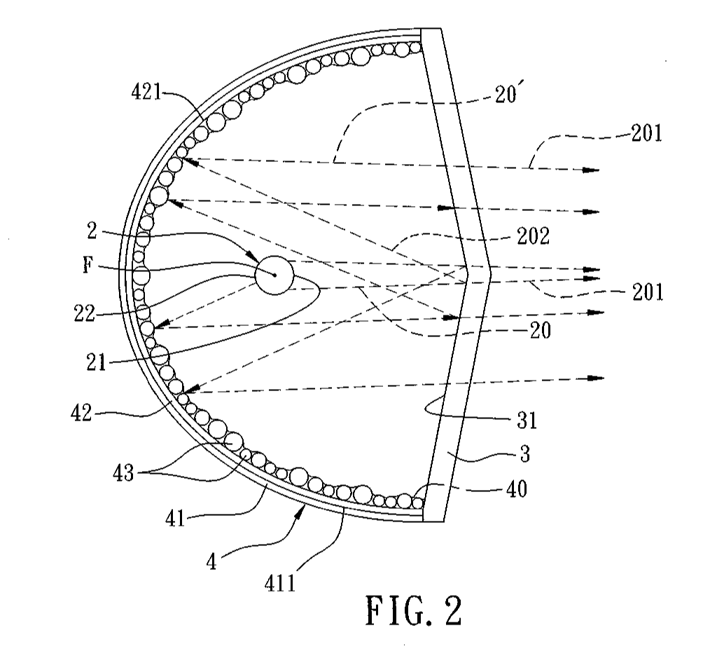

Referring to FIGS. 2 to 4, a linearly polarized light converter according to the preferred embodiment of the present invention uses a polarization recycling mechanism for separating a first linearly polarized wave 201 of an unpolarized wave 20 that includes the first linearly polarized wave 201 and a second linearly polarized wave 202 orthogonal with the first linearly polarized wave 201, and that is produced by a light source 2. The linearly polarized light converter of the present invention comprises a polarized beam splitter 3 disposed on a first side 21 of the light source 2, and a metallic reflector 4 disposed on a second side 22 of the light source 2 that is opposite to the first side 21.

It is worth mentioning that when the first linearly polarized wave 201 of the present invention is a transverse magnetic wave (TM wave), the second linearly polarized wave 202 is a transverse electric wave (TE wave). However, when the first linearly polarized wave 201 is a TE wave, the second linearly polarized wave 202 is a TM wave. This is due to the fact that the TE wave and the TM wave are two linearly polarized waves that are orthogonal to each other, and any light wave can be decomposed into two linearly polarized waves that are orthogonal to each other. In the preferred embodiment of this invention, the first linearly polarized wave 201 is a TM wave, and the second linearly polarized wave 202 is a TE wave. A monochromatic or chromatic light bulb, a cold-cathode fluorescent lamp (CCFL), or a light emitting diode (LED) may be suitably used as the light source 2 in this invention.

The polarized beam splitter 3 is adapted to receive the unpolarized wave 20, transmits the first linearly polarized wave (i.e., the TM wave) 201 therethrough, and reflects the second linearly polarized wave (i.e., the TE wave) 202.

A broadband wide-angle polarization beam splitter, a prism, a multi-layered film, a dielectric grating, a linear grating structure, or any combination thereof may be suitably used as the polarized beam splitter 3 of this invention. Preferably, the polarized beam splitter 3 has a surface 31 facing the light source 2. The surface 31 of the polarized beam splitter 3 has a cross section that is parabolic, spherical, conical, rectangular, square, polyhedral conical, or any combination thereof.

Preferably, the polarized beam splitter 3 and the metallic reflector 4 provided respectively on the first and second sides 21, 22 of the light source 2 are adapted to encompass the light source 2. More preferably, the metallic reflector 4 includes a substrate 41 having a surface 411, a metal layer 42 formed on the surface 411 of the substrate 41, and a plurality of metal particles 43 distributed over the metal layer 42. Each of the metal particles 43 is made of gold (Au), silver (Ag), copper (Cu), aluminum (Al), or an alloy thereof. The surface 411 of the substrate 41 has at least one focal point (F), and is parabolic, spherical, conical, rectangular, square, polyhedral conical, or any combination thereof.

Citing an example, when the surface 411 of the substrate 41 of the metallic reflector 4 is made up of (n) number of interconnected parabolic surfaces, the surface 411 has (n) number of focal points (F), and can selectively cooperate with (n) number of light sources 2 that are proximate to the aforesaid (n) number of focal points (F). In the preferred embodiment of this invention, the light source 2 is a light emitting diode that is disposed at or near the focal point (F) of the surface 411 of the substrate 41. Each of the metal particles 43 has a shape of a spheroid, a trigonal pyramid, a tetragonal pyramid, an ellipsoid, a polyhedral cone, or any combination thereof. In this embodiment, each metal particle 43 is a spheroid. The wavelength of the unpolarized wave 20 is in the visible spectrum (ranging between 400 nm˜700 nm), and is defined as λ.

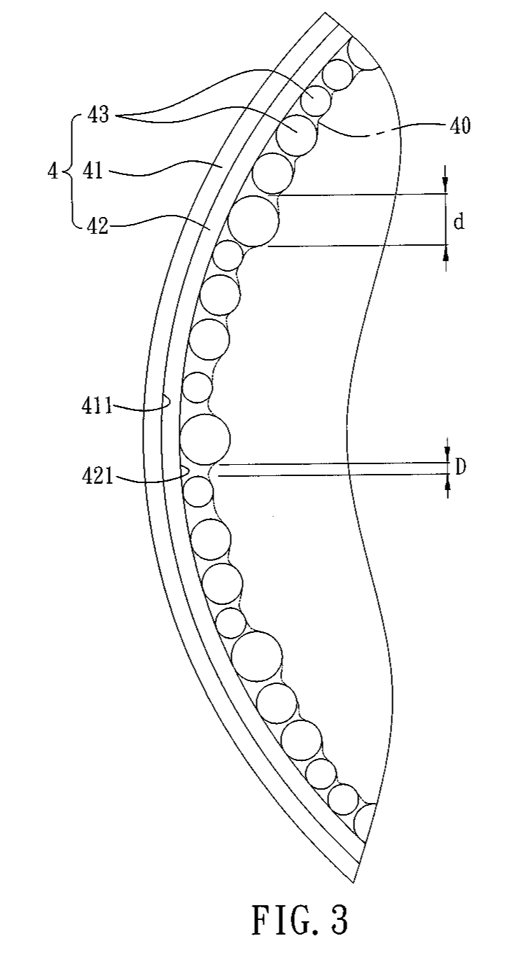

With reference to FIG. 3, more preferably, each metal particle 43 has a granular diameter (d) ranging from 0.1λ to 100λ, and the distance (D) between each two adjacent ones of the metal particles 43 ranges from 0.1λ˜100λ. It is worth mentioning that the metal particles 43 are formed on a surface 421 of the metal layer 42 by a spraying process. In this embodiment, the metal particles 43 of the metallic reflector 4 cooperatively define a rough surface 40. Referring back to FIG. 2, it is apparent that the rough surface 40 is used for receiving the reflected second linearly polarized wave 202 so as to convert the same into an elliptical polarized wave 20′ and for reflecting the elliptical polarized wave 20′.

In the preferred embodiment of this invention, when, for example, the granular diameter (d) of each metal particle 43 is 0.0022 mm, and the distance (D) between two adjacent ones of the metal particles 43 is 0.005 mm, the average polarization conversion efficiency of the rough surface 40 can be calculated to be 0.65. Hence, the power efficiency of a single reflection is obtained to be about 82.5%, that is,

$$Power efficiency = [ \frac{0.5 + ( 0.5 \times 0.65 )}{1} ] \times 100 \% = 82.5 \%$$

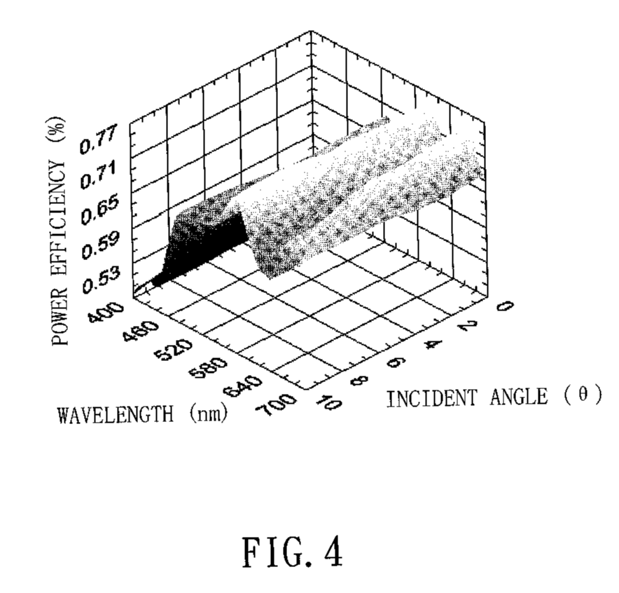

FIG. 4 is a 3D chart of the preferred embodiment, illustrating the power efficiencies (%) of the polarization converter of the present invention at different wavelengths (λ) and incident angles (θ).

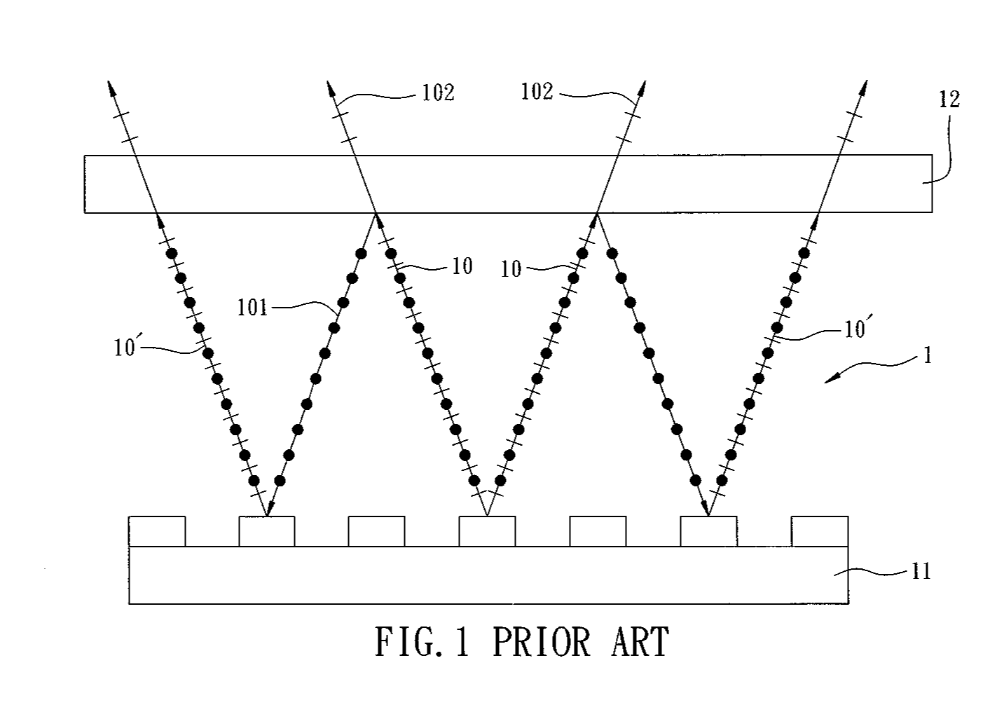

The present invention uses the rough surface 40 cooperatively defined by the metal particles 43 to replace the conventional metallic diffraction grating 11 (see FIG. 1) so as to minimize the time and equipment costs associated with the photolithography and etching steps in producing the conventional metallic diffraction grating 11. Further, because of the rough surface 40 defined by the metal particles 43 of the metallic reflector 4 of the linearly polarized light converter of the present invention, the polarization efficiency of the linearly polarized light converter is not affected by the azimuth of the electromagnetic wave relative to an incident plane (that is, it is not limited by the cylindrical electromagnetic wave). Hence, the linearly polarized light converter of the present invention is suitable for use with a spherically shaped electromagnetic wave light source (for example, an LED backlight light source), and may be suitably applied to a micro-liquid-crystal projector.

In summary, the linearly polarized light converter of the present invention can provide linearly polarized light with minimal consumption of energy while requiring minimal production costs, and can allow for an increase in the selection of light sources to be used therewith. Hence, the object of the present invention is satisfied.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A linearly polarized light converter using a polarization recycling mechanism for separating a first linearly polarized wave of an unpolarized wave that includes the first linearly polarized wave and a second linearly polarized wave orthogonal with the first linearly polarized wave, and that is produced by a light source, said linearly polarized light converter comprising:
a polarized beam splitter disposed on a first side of the light source for receiving the unpolarized wave, transmitting the first linearly polarized wave therethrough, and reflecting the second linearly polarized wave; and
a metallic reflector disposed on a second side of the light source that is opposite to the first side, wherein said metallic reflector includes a metal layer and a plurality of metal particles distributed over said metal layer to cooperatively define a rough surface, said rough surface converting the reflected second linearly polarized wave into an elliptical polarized wave and reflecting the elliptical polarized wave therefrom.

2. The linearly polarized light converter of claim 1, wherein each of said metal particles has a shape of a spheroid, a trigonal pyramid, a tetragonal pyramid, an ellipsoid, a polyhedral cone, or any combination thereof.

3. The linearly polarized light converter of claim 1, wherein each of said metal particles is made of gold, silver, copper, aluminum, or an alloy thereof.

4. The linearly polarized light converter of claim 1, wherein, when a wavelength of the unpolarized wave is defined as λ, each of said metal particles has a diameter ranging from 0.1λ to 100λ, and each two adjacent ones of said metal particles is spaced apart from each other at a distance ranging from 0.1λ to 100λ.

5. The linearly polarized light converter of claim 4, wherein the wavelength of the unpolarized wave is in the visible spectrum.

6. The linearly polarized light converter of claim 1, wherein said polarization beam splitter is a broadband wide-angle polarization beam splitter.

7. The linearly polarized light converter of claim 1, wherein said polarization beam splitter is a prism, a multi-layered film, a dielectric grating, a linear grating structure, or any combination thereof.

8. The linearly polarized light converter of claim 1, wherein said polarization beam splitter has a surface facing the light source and having a cross section that is parabolic, spherical, conical, rectangular, square, polyhedral conical, or any combination thereof.

9. The linearly polarized light converter of claim 1, wherein said light source is a light bulb or a light emitting diode.

10. The linearly polarized light converter of claim 1, wherein said polarization beam splitter and said metallic reflector are adapted to encompass the light source.

11. The linearly polarized light converter of claim 10, wherein said metallic reflector further includes a substrate having a surface, said metal layer being formed on said surface of said substrate, said surface of said substrate having at least one focal point, the light source being disposed at or near the focal point.

12. The linearly polarized light converter of claim 11, wherein said surface of said substrate is parabolic, spherical, rectangular, square, polyhedral conical, or any combination thereof.
